(19) United States
(12) Patent Application Publication
(10) Pub. No.: US 2011/0164465 A1
(43) Pub. Date: Jul. 7, 2011

(54) HEAT EXCHANGER WITH HELICAL FLOW PATH

(76) Inventor: Robert Smith, Huntington Beach, CA (US)

(21) Appl. No.: 12/683,229

(22) Filed: Jan. 6, 2010

(51) Int. Cl. B01F 7/08; B01F 15/06

(52) U.S. Cl. 366/147

(57) ABSTRACT

A device for stationary material mixing a first fluid and for effecting heat transfer from the first fluid to a second fluid. The device is characterized as having a longitudinal axis, first conduit having a first diameter, a length, a substantially circular circumference and a center line coincident with the longitudinal axis, the first conduit housing a plurality of mixing elements for acting upon the first fluid passing therethrough. A second conduit is provided having a second diameter greater than the first diameter, a length, a substantially circular circumference and a center line coincidence with the longitudinal axis and a continuous baffle helically extending within a channel created between the exterior of the first conduit and the interior of the second conduit, said second fluid travelling within said channel along the helix formed by the continuous baffle.

### TECHNICAL FIELD

The present invention is directed to a device for effecting heat transfer from a first fluid medium to a second fluid medium and for enhancing mixing and uniform distribution of the second fluid within the confines of a conduit.

### BACKGROUND OF THE INVENTION

It is well known in the processing of fluid streams to employ static mixers and heat exchangers as enhancements in promoting product uniformity and adjusting product temperature. The added benefit to such a system is that thermal energy contained within the fluid to be mixed can oftentimes be transferred to a second fluid to take advantage of such thermal energy which would otherwise be wasted.

Mixers can contain active elements such as paddles and rotors although it is quite common to provide static elements whereby the turbulent flow of the fluids in and around these elements enhance fluid mixing without the need for moving parts which inherently add to the cost of the mixing operation both in terms of power requirements and labor intensive maintenance procedures. Many static mixers rely on a mixing element configuration that presents a set of interstices to the product flow. Elements of this type divide a fluid stream along a mixing path and recombine locally created sub streams into a more homogeneous mixture.

It has long been realized that static mixers which can be made to work efficiently provide certain economic advantages over dynamic mixers. Static mixers employ no moving parts and, as such, are generally considered less expensive to configure and certainly much less expensive to maintain while providing the user with an extended life for the mixer product in service.

There have been a number of prior approaches taken to the design and implementation of static mixers. They generally involve the machining, molding, casting or other fabrication of components which are coupled by some type of permanent attachment means to a conduit side wall. Although some designs work better than others, virtually all prior devices can be characterized as having certain “dead zones”. In these areas, fluids, even in turbulent flow, can accumulate and remain virtually unmixed. Also, in dealing with certain types of fluid streams, the various static mixing elements can act to entrap or entangle portions of the fluid stream which can result in clogging or plugging of the conduit in its entirety.

Static or motionless mixers are in common use in industrial process applications that include heat transfer, chemical reactions, plastic coloration and water treatment, among others. Mixers of this type are installed in processing pipe lines and handle the flow of materials under both laminar and turbulent conditions generally on a continuous rather than batch process basis.

In fact, it is well known that an extended length of pipe alone can be used to mix fluids. See Chemical Engineering Handbook, 5^{th} Ed., p. 21-24 and 21-26. Reynolds numbers must be high enough to assure turbulence and pipe lengths of the order of 100 pipe diameters or more are usually required. The energy necessary to achieve mixing comes with the pressure drop required to move the fluid through the pipe.

Flow mechanisms in laminar and turbulent flow are quite different. In laminar flow, viscous forces which restrict flow and result in pressure drops across the mixing device are proportional to the flow rate Q. In turbulent flow, the major resistance to fluid flow results from the internal sources required to produce eddies and vortices, and the pressure drop is proportional to the flow rate Q².

The above-recited factors must be taken into account when designing a motionless mixer handling both laminar and turbulent flow applications. In laminar flow, fluid flow must be divided, reoriented and recombined so as to produce a large number of striations. The result is a large interfacial area between components which enhances molecular diffusion. By contrast, in turbulent flow mixing, the creation of vortices is encouraged to provide the opportunity for fluid components to interact with one another so as to produce smaller eddies or vortices so as to randomize the distribution of flow components. As such, laminar flow mixing depends upon the systematic division and reassembly of fluids while turbulent flow mixing relies upon chaotic mechanisms.

In creating a static or motionless mixer, at least four objectives are sought:
(1) Turbulent flow is encouraged at low Reynolds numbers so as to encourage mixing at low flow rates.
(2) The mixing device should be as short as possible.
(3) The mixer should be relatively free from “plugging effects” for materials such as fibers, clumps, and particulates which are often present in pipe lines.
(4) The pressure drop should be as low as possible.

It has further been observed that if a device is effective under laminar flow conditions, it is invariably effective for turbulent flow. On the other hand, if a device is effective for turbulent flow, it is not necessarily effective for laminar flow. It is also noted that when a motionless mixer is installed in a pipe, the Reynolds number at which turbulence and therefore mixing occurs would be lower. In fact, primitive motionless mixers consisted of a pipe fitted with chain or ball bearings. However, such configurations resulted in high pressure drops and were very susceptible to plugging.

It is thus an object of the present invention to provide a device in which a moving fluid product is both mixed and subject heat transfer as a result of its contact with fluid medium employed for that purpose.

It is a further object of the present invention to accomplish the above-referenced objects while, at the same time, improving efficiency of such a device dramatically as compared to devices offered for this purpose commercially.

It is yet a further object of the present invention to provide a stationary material mixing apparatus capable of producing turbulent flow at relatively low Reynolds numbers, to be as short as practical, to be free from plugging effects for materials such as fibers, clumps and particulates and to produce a relatively low pressure drop.

These and further objects will be more readily apparent when considering the following disclosure and appended claims.

### SUMMARY OF THE INVENTION

A device for stationary material mixing a first fluid and for effecting heat transfer from the first fluid to a second fluid. The device is characterized as having a longitudinal axis, first conduit having a first diameter, a length, a substantially circular circumference and a center line coincident with the longitudinal axis, the first conduit housing a plurality of mixing elements for acting upon the first fluid passing therethrough. A second conduit is provided having a second diameter greater than the first diameter, a length, a substantially circular circumference and a center line coincidence with the longitudinal axis and a continuous baffle helically extending within a channel created between the exterior of the first conduit and the interior of the second conduit, said second fluid travelling within said channel along the helix formed by the continuous baffle.

### BRIEF DESCRIPTION OF THE FIGURES

FIG. 1 is the device for stationary material mixing of the present invention in partial cross section.

FIG. 2 is a cross sectional view of the device depicted in FIG. 1 taken along line 2-2 thereof.

FIG. 3 is a partial cross sectional view of a first conduit shown as part of the device of FIG. 1 showing the material mixing apparatus in a first orientation.

FIG. 4 is a view similar to that of FIG. 3 wherein the orientation of the first conduit has been rotated in order to show the mixing elements in a second orientation.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments in the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above in order that the detailed description which follows may be better understood, and in order that the present contribution to the art may be appreciated. There are, of course, additional features of the invention that will be described hereinafter and which form additional subject matter of the claims appended hereto. Those skilled in the art will appreciate that the concept upon which this disclosure is based readily may be utilized as a basis for the designing of other structures, methods and systems for carrying out the several purposes of the present invention. It is important, therefore, that the claims be regarded as including such equivalent constructions insofar as they are do not depart from the spirit and scope of the present invention.

Certain terminology and derivations thereof may be used in the following description for the convenience and reference only and will not be limiting. For example, words such as “upward,” “downward,” “left,” and “right” refer to directions in the drawings to which reference is made and is otherwise stated. Similarly, words such as “inward” and “outward” refer to directions toward and away from, respectively, the geometric center of a device or area and designated parts thereof. Reference in the singular tense include the plural and vice-versa, unless otherwise noted.

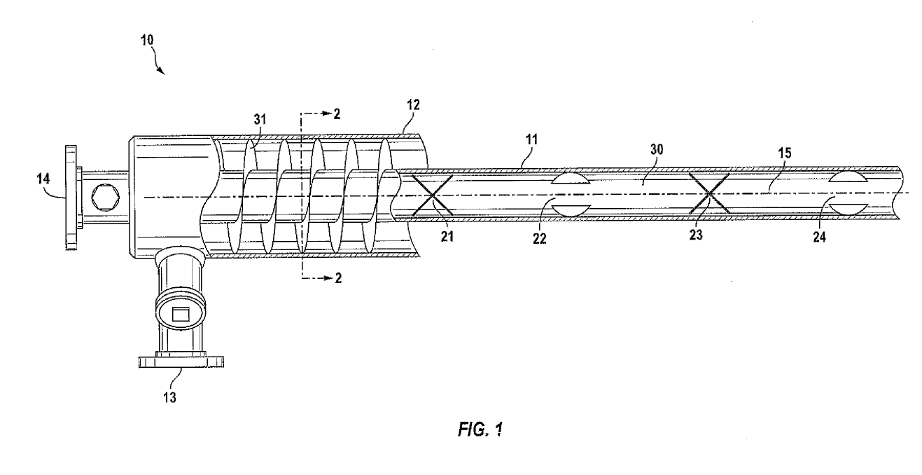

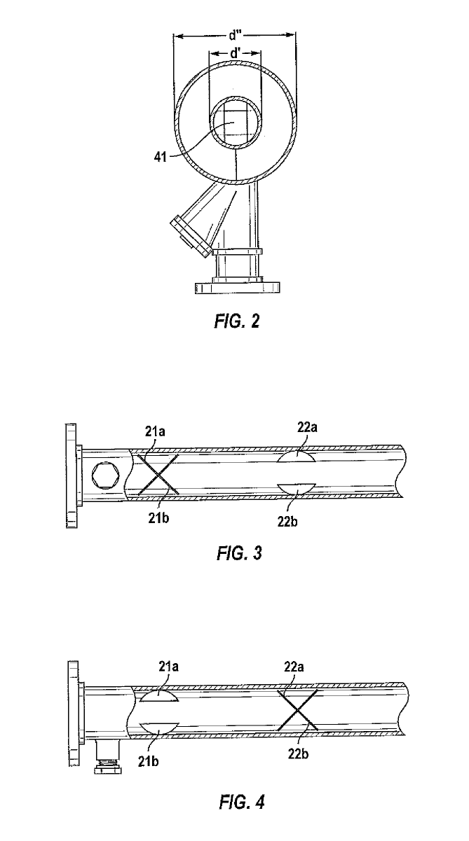

Turning first to FIG. 1, device 10 for stationary material mixing is depicted. Device 10 is characterized as having longitudinal axis 15, first conduit 11 having a first diameter d′ (FIG. 2), a length, a substantially circular circumference best seen in FIG. 2 and a center line coincident with longitudinal axis 15.

Device 10 also includes a second conduit 12 having a second diameter d″ greater than first diameter d′, a length, a substantially circular circumference best seen in FIG. 2 and a center line also coincident with longitudinal axis 15.

First conduit 11 contains a plurality of mixing elements 21, 22, 23, 24, etc for acting upon first fluid 30 passing therethrough. First fluid 30 enters first conduit 11 through inlet fitting 14 and exits downstream on the light hand portion of device 10. The preferred nature of mixing elements 21, 22, 23, 24, etc., will be described in more detail hereinafter.

As noted, second conduit 12 is provided with a second diameter d″ greater than first diameter d′, a length coextensive with length of first conduit 11 and inlet 13. In order to enhance heat transfer between fluid 30 and that fluid travelling within conduit 12, continuous baffle 31 is created between the exterior of first conduit 11 and interior of second conduit 12 such that fluid travelling within this channel travels along helix 31 formed by this continuous baffle.

It is a preferred embodiment of the present invention to provide a stationary material mixing apparatus within first conduit 11 capable of producing turbulent flow at relatively low Reynolds numbers so as to be as short as practical, to be free from plugging effects from materials such as fibers, clumps and particles and to produce a relatively low pressure drop. An ideal environment for use of the present invention is for the mixing of hot sludge which can oftentimes contain debris that can oftentimes clog such a mixing device unless great care is taken in the selection of mixing elements to provide optimal mixing while remaining free from plugging.

Mixing elements ideally suited for use herein are those disclosed in applicant's U.S. Pat. No. 5,758,967, the disclosure of which is incorporated herein by reference. Specifically, mixing elements 21, 22, 23, 24, etc., are shown. In this regard, specific reference is made to FIGS. 3 and 4 for discussion of, for example, mixing elements 21 and 22 located within first conduit 11

In turning to FIGS. 3 and 4, mixing elements 21a, 21b, 22a and 22b are characterized as having no edges or surfaces perpendicular to longitudinal axis 15 and are sized so that no such elements are in contact with one another resulting in an open region of travel 41 (FIG. 2) for fluids passing through first conduit 11 along longitudinal axis 15. Ideally, each mixing element is seated within first conduit 11 at an angle between approximately 30° to 45° to said longitudinal axis. The mixing elements 21a, 21b, 22a and 22b are positioned within first conduit 11 so that at least 75% of the conduit circumference in any plane is free of any mixing element. The various mixing elements are provided with no points of contact so that there are no “crotches” which would otherwise result in material hang up. It is the intent of applicant to provide a motionless mixer system enabling debris having effective diameters of 75% or more of the conduit diameter to pass through the conduit without entrainment.

Although the mixing device composed of first conduit 11 and the described mixing elements located therein can be used for mixing fluids such as gases, liquids and solids and combinations of such materials, the genesis of this construction is the result of activities conducted in the sewage treatment field. Such mixers are oftentimes used to combine the watering agents with sewage flow just upstream of a filter press. The vast majority of static mixers of the prior art eventually plug or clog in this application. Material migrate to and accumulate in low pressure or “dead spots” and long fibers will catch and build up in “crotches.” Both of these effects allow and encourage more material to accumulate until the mixer finally plugs. By providing open region 41 and by providing the placement of mixing elements whereby at least 75% of the conduit circumference in any plane is clear of any ancillary structure accomplishes the goal of preventing material hang up in the typical sewage treatment field. Even the most problematic components “slide” over the mixing elements without clogging under both laminar and turbulent flow conditions. Ideally, mixing elements are provided as pairs 21a, 21b, 22a and 22b, etc, provided as complimentary pairs cause material flowing through first conduit 11 to rotate about axis 15 in opposite directions.

Preferably, the mixing elements are shown of a circular segment configuration each of a height approximately d′/10 and a radius of d′/2. The various mixing elements are set in a non-opposing fashion at the pipe wall so as to present to the fluid in any plane normal to the axis of the conduit a non-symmetrical cross-section. This serves to break up the normal circular symmetry of flow and to substantially reduce the conduit length necessary to achieve effective mixing. As such, mixing is accomplished with less of a pressure drop than would otherwise be required to obtain a given degree of mixing within an open pipe coupled with the ability of the present mixer to pass an object which is large compared to the inside diameter of first conduit 11.

As noted, many of those dealing with the processing of heated sludge would find it of benefit to be able to reclaim heat from the body of sludge passing through a processing facility that includes motionless mixing elements such as those described herein. By employing the mixing elements as described above, significant turbulence is created within first conduit 11 which in turn enhances heat exchange to a fluid external thereto.

This goal is further achieved by providing the continuous baffle 31 helically extending within the channel created between the exterior of first conduit 11 and interior of second conduit 12. The use of this baffle increases the velocity of fluid being acted upon by continuous helical baffle 30 thus increasing turbulence and resultant transfer of thermal energy. Increased fluid velocity reduces the “film coefficient” on the exterior wall of first conduit 11 where, ordinarily, fluid velocity is low. By increasing this velocity, the coefficient is reduced and the transfer of thermal energy made more efficient.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships or operations as described. Various modifications, alternative constructions, changes and equivalents will readily occur to those skilled in the art may be employed as suitable without departing from the true spirit and scope of the invention. Such changes might involve alternative materials, components, structural arrangements, sizes, shapes, forms, functions, operational features or the like.

Therefore, the above description and illustration should not be considered as limiting the scope of the invention, which is defined by the appended claims.

What is claimed is:

1. A device for stationary material mixing of a first fluid and for effecting heat transfer from said first fluid to a second fluid, said device having a longitudinal axis, a first conduit having a first diameter, a length, a substantially circular cross section and a center line coincident with said longitudinal axis, said conduit having a plurality of mixing elements for acting upon said first fluid passing therethrough, a second conduit having a second diameter greater than first diameter, a length, a substantially circular circumference and a center line coincident with said longitudinal axis, a continuous baffle helically extending within a channel created between the exterior of said first conduit and the interior of said second conduit, said second fluid travelling within said channel along the helix formed by said continuous baffle.

2. The device of claim 1 wherein said mixing elements are provided in said first conduit in complimentary pairs, wherein adjacent mixing elements cause fluid passing within said conduit to rotate in opposite directions.

3. The device of claim 1 wherein each mixing element is seated within said first conduit at an angle between approximately 30 to 45 degrees to said longitudinal axis.

4. The device of claim 1 wherein said mixing elements are in the form of circular segments wherein each mixing element is characterized as being widest in profile at its midpoint and narrowest at its longitudinal end points.

5. The device of claim 4 wherein each mixing element is of a height equal to approximately d′/10 and a radius of approximately d′/2 wherein d′ is the diameter of the conduit.

6. The device of claim 1 wherein said mixing elements are sized and positioned within said first conduit such that said first conduit is capable of passing therethrough solid matter having a diameter of at least 75% of the diameter of said first conduit.
